(19) United States
(12) Patent Application Publication
(10) Pub. No.: US 2013/0236245 A1
(43) Pub. Date: Sep. 12, 2013

(54) FRAME ASSEMBLY BASE FOR FRAME STRUCTURES

(71) Applicant: Chuanying Yu, Changchun City (CN)

(72) Inventor: Chuanying Yu, Changchun City (CN)

(73) Assignee: CHANGCHUN RAILWAY VEHICLES CO. LTD., Changchun City, Jilin (CN)

(21) Appl. No.: 13/701,400

(22) PCT Filed: Jul. 12, 2011
(86) PCT No.: PCT/CN11/77050

§ 371 Date: Feb. 8, 2013

(30) Foreign Application Priority Data
Nov. 24, 2010 (CN) 201020622003.6

(51) Int. Cl. F16B 1/00

(52) U.S. Cl. CPC F16B 1/00
USPC 403/403

(57) ABSTRACT

The utility model provides a frame assembly base for frame structures, being characterized in that, a longitudinal beam and a transverse beam, the transverse beam and an intermediate beam, the intermediate beam and a transverse reinforcing beam, and the longitudinal beam and the transverse reinforcing beam are all connected by bolts, and connecting blocks are provided at connections between the longitudinal beam and the transverse beam and between the longitudinal beam and the transverse reinforcing beam. In the present utility model, bolt connections are used throughout the base, and connecting blocks are provided at the connections between the longitudinal beam and the transverse beam and between the longitudinal beam and the transverse reinforcing beam, so that frame widths can be adjusted to be adapted to assembling of frames having different widths by adjusting widths of the connecting blocks, thereby saving manufacturing costs of tooling, reducing difficulties of tooling storage and management. The base is detachable to facilitate storage and management.

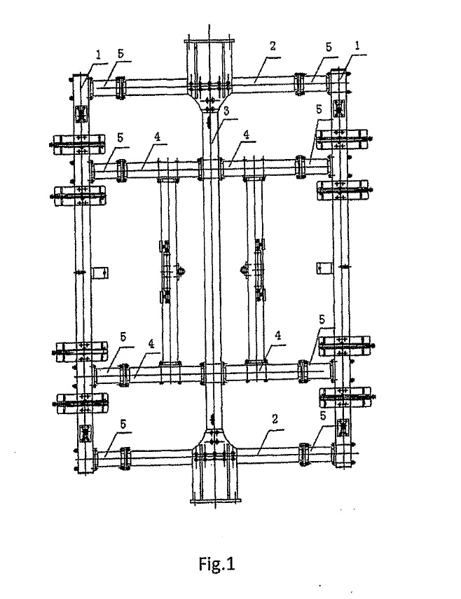

### FIELD OF INVENTION

The present utility model relates to a base in a frame assembly tooling used for frame structures.

### DESCRIPTION OF THE RELATED ART

Nowadays, when welding and assembling bogie frameworks, a new set of tooling needs to be manufactured for each type of rail car due to different widths of the frameworks, resulting in wasting human and material resources, increasing costs for manufacturing and welding the frameworks, and raising technical requirements for workers, which means that the workers have to be familiar with all of various tooling. In addition, using of welding structures in all tooling also increase difficulties of tooling storage and management.

### SUMMARY OF INVENTION

One object of the present utility model is to provide a detachable universal base for a frame assembly tooling to enhance versatility of tooling for welding and assembling bogie frameworks, save costs, and reduce workloads for designing tooling and difficulty of tooling management.

In order to achieve the above object, the present utility model provides a frame assembly base for frame structures characterized in that, a longitudinal beam and a transverse beam, the transverse beam and an intermediate beam, the intermediate beam and a transverse reinforcing beam, and the longitudinal beam and the transverse reinforcing beam are all connected by bolts, and connecting blocks are provided at connections between the longitudinal beam and the transverse beam and between the longitudinal beam and the transverse reinforcing beam.

In the present utility model, all of connections in the frame assembly base are bolt connections, and connecting blocks are provided at the connections between the longitudinal beam and the transverse beam and between the longitudinal beam and the transverse reinforcing beam, so that frame widths can be adjusted to be adapted to assembling of frames having different widths by adjusting widths of the connecting blocks, thereby reducing manufacturing costs of tooling and facilitating tooling storage and management.

### BRIEF DESCRIPTION OF THE DRAWINGS

The accompanying FIGURE is a diagram showing structures of a frame assembly base for frame structures according to the present utility model.

### DETAILED DESCRIPTION OF PREFERRED EMBODIMENTS

With reference to the accompanying figure, a longitudinal beam 1 and a transverse beam 2, the transverse beam 2 and an intermediate beam 3, the intermediate beam 3 and a transverse reinforcing beam 4, and the longitudinal beam 1 and the transverse reinforcing beam 4 are all connected by bolts, and connecting blocks are provided at connections between the longitudinal beam and the transverse beam and between the longitudinal beam and the transverse reinforcing beam. Based on frame structures, clamps are fixedly positioned on the frame structures, so that the base is applicable to frame assemblies having different widths.

What is claimed is:

1. A frame assembly base for frame structures, being characterized in that, a longitudinal beam and a transverse beam, the transverse beam and an intermediate beam, the intermediate beam and a transverse reinforcing beam, and the longitudinal beam and the transverse reinforcing beam are all connected by bolts, and connecting blocks are provided at connections between the longitudinal beam and the transverse beam and between the longitudinal beam and the transverse reinforcing beam.
